(19) United States
(12) Patent Application Publication
(10) Pub. No.: US 2016/0029092 A1
(43) Pub. Date: Jan. 28, 2016

(54) METHOD AND SYSTEM FOR PROCESSING INTERACTIVE USER OPERATION INFORMATION OF DIGITAL TV

(71) Applicant: Shenzhen National Engineering Laboratory of Digital Television Co., Ltd., Shenzhen, Guangdong (CN)

(72) Inventors: Zhuo SUN, SR., Shenzhen Guangdon (CN); Xinguo LI, Shenzhen Guangdon (CN); Yi GAO, Shenzhen Guangdon (CN); Xing WANG, Shenzhen Guangdon (CN); Jun GONG, Shenzhen Guangdon (CN); Baolong ZHAO, Shenzhen Guangdon (CN)

(21) Appl. No.: 14/421,756

(22) PCT Filed: Dec. 18, 2013
(86) PCT No.: PCT/CN2013/089558

§ 371 Date: Feb. 13, 2015

(30) Foreign Application Priority Data
Apr. 11, 2013 (CN) 201310125023.0

(51) Int. Cl. H04N 21/475; H04N 21/478; H04N 21/4367; H04N 21/45; H04N 21/422

(52) U.S. Cl. CPC H04N 21/4753; H04N 21/4508; H04N 21/42207; H04N 21/4367; H04N 21/478

(57) ABSTRACT

A method, a system, and a related device for processing interactive user operation information of a digital TV are provided, which are used to safely store the user operation information, prevent the user operation information from being captured or attacked, improve convenience of the user operation, and obtain desirable user experience. The method according to the embodiments of the present invention comprises: sending an information request message to a matching remote control, the information request message comprising first operation information, so that the matching remote control searches, according to the first operation information, for second operation information matching the first operation information; and receiving the second operation information matching the first operation information and sent by the matching remote control.

This application is a national phase of International Application No. PCT/CN2013/089558, titled “METHOD AND SYSTEM FOR PROCESSING INTERACTIVE USER OPERATION INFORMATION OF DIGITAL TELEVISION”, filed on Dec. 16, 2013, which claims priority to Chinese patent application No. 201310125023.0 titled “METHOD AND SYSTEM FOR PROCESSING INTERACTIVE USER OPERATION INFORMATION OF DIGITAL TELEVISION” and filed with the State Intellectual Property Office on Apr. 11, 2013 which are incorporated herein by reference in their entireties.

### FIELD

The present disclosure relates to the technical field of digital television, and in particular to a method and system for interactively processing user operation information of digital television and an associated device.

### BACKGROUND

With the development of intelligentization and networking of the digital television, the digital television has more and more functions like a computer. Hence the digital television may be used as a computer to log-in a micro blog, a mailbox, or online payment with Internet bank, and the like. In this case, private user operation information such as an account number, a secret code and various passwords are involved. A remote control of the digital television can not be conveniently used as a mouse or a keyboard, and therefore, it is complicate to input various user operation information. In addition, how to store the private user operation information securely is also an issue desired to be solved.

Currently, the private user operation information is stored in the digital television, like that in the computer, i.e. the information is encrypted and stored locally. In practice, the local storage may cause a security risk.

### SUMMARY

For the above disadvantage, embodiments of the present disclosure provide a method and system for interactively processing user operation information of digital television and an associated device. Hence, security and convenience of the user operation information will be improved and a better user experience will be obtained.

A first aspect of the embodiments of the present disclosure provides a method for interactively processing user operation information of digital television, including:
sending an information request message including first operation information to a paired remote control, which is used by the paired remote control to search the second operation information matching the first operation information based on the first operation information; and
receiving the second operation information matching the first operation information sent by the paired remote control.

A second aspect of the embodiments of the present disclosure provides another method for interactively processing user operation information of digital television, including:
receiving first and second operation information input by a user with a paired remote control and binding the first and second operation information to obtain an information request message including the first and second operation information; and
sending the information request message obtained by binding the first and second operation information to the paired remote control, wherein the paired remote control stores the first and second operation information included in the information request message.

A third aspect of the embodiments of the present disclosure provides still another method for interactively processing user operation information of digital television, including:
receiving information request message sent by a device;
wherein, in the case that the information request message includes first operation information, it is determined based on the first operation information whether second operation information matching the first operation information is stored, and if the second operation information is stored, the second operation information found to be matching the first operation information is sent to the device; in the case that the information request message includes the first and second operation information, the first and second operation information are stored.

A fourth aspect of the embodiments of the present disclosure provides a device, including:
a first sending unit, configured to send an information request message including first operation information to a paired remote control, trigger the paired remote control to search for second operation information matching the first operation information based on the first operation information; and
a first receiving unit, configured to receive the second operation information matching the first operation information sent by the paired remote control.

A fifth aspect of the embodiments of the present disclosure provides another device, including:
a second receiving unit, configured to receive first and second operation information input by a user with a paired remote control and bind the first and second operation information to obtain an information request message including the first and second operation information; and
a second sending unit, configured to send the information request message obtained by binding the first and second operation information to the paired remote control, trigger the paired remote control to store the first and second operation information included in the information request message.

A sixth aspect of the embodiments of the present disclosure provides a remote control, including:
a communication module, configured to receive an information request message sent by a device and send to the device second operation information which is found to be matching first operation information; and
a storage module, configured to determine, based on the first operation information, whether the second operation information matching the first operation information is stored and search for the second operation information matching the first operation information, in the case that the information request message includes the first operation information; and store the first and second operation information in the case that the information request message includes the first and second operation information.

A seventh aspect of the embodiments of the present disclosure provides a system for interactively processing user operation information of digital television, including the device provide by the fourth or fifth aspect and the remote control provided by the sixth aspect.

It can be seen from the above technical solution, the embodiments of the present disclosure have advantages as follows.

On one hand of the embodiments of the present disclosure, in a case that the user operation information has been stored in the paired remote control, the device sends the information request message including the first operation information to the paired remote control, then the paired remote control searches for the second operation information matching the first operation information based on the first operation information and sends the second operation information to the device, and thereby a user login is completed.

On the other hand of the embodiments of the present disclosure, if the user operation information is input for the first time and the operation information has not been stored in the paired remote control, the device receives through the paired remote control the first and second operation information input by a user and binds the first and second operation information to obtain an information request message including the first and second operation information; and the paired remote control stores the received first and second operation information for subsequent use. In the embodiments of the present disclosure, the user operation information is stored securely by simply storing the user operation information in the paired remote control. Hence the stored user operation information may be called conveniently, the convenience of the user operation is improved, and the user experience is improved.

### BRIEF DESCRIPTION OF THE DRAWINGS

The drawings needed to be used in the description of the embodiments of the present disclosure will be described briefly as follows, so that the technical solutions according to the embodiments of the disclosure will become clearer. It is obvious that the drawings in the following description are only some embodiments of the present disclosure. For those skilled in the art, other drawings may be obtained according to these drawings without any creative work.

FIG. 1 is a basic flowchart of a method for interactively processing user operation information of digital television according to an embodiment of the present disclosure;

FIG. 2 is a basic flowchart of another method for interactively processing user operation information of digital television according to an embodiment of the present disclosure;

FIG. 3 is a basic flowchart of still another method for interactively processing user operation information of digital television according to an embodiment of the present disclosure;

FIG. 4a is a basic flowchart of a method for interactively processing user operation information of digital television according to an embodiment of the present disclosure;

FIG. 4b is a diagram of information interaction between a digital television/set-top box and a remote control according to an embodiment of the present disclosure;

FIG. 5a is another basic flowchart of a method for interactively processing user operation information of digital television according to an embodiment of the present disclosure;

FIG. 5b is a diagram of information interaction between a digital television/set-top box and a remote control according to an embodiment of the present disclosure;

FIG. 6 is a basic schematic structural diagram of a device according to an embodiment of the present disclosure;

FIG. 7 is a basic schematic structural diagram of a device according to an embodiment of the present disclosure;

FIG. 8 is a basic schematic structural diagram of a remote control according to an embodiment of the present disclosure;

FIG. 9a is a schematic structural diagram of a system for interactively processing user operation information of digital television according to an embodiment of the present disclosure; and

FIG. 9b another schematic structural diagram of a system for interactively processing user operation information of digital television according to an embodiment of the present disclosure.

### DETAILED DESCRIPTION

The technical solution according to the embodiments of the present disclosure will be described clearly and completely as follows in conjunction with the drawings in the embodiments of the present disclosure. It is obvious that the described embodiments are only a part of the embodiments according to the present disclosure. All the other embodiments obtained by those skilled in the art based on the embodiments in the present disclosure without any creative work belong to the scope of the present disclosure.

The embodiments of the present disclosure provide a method and system for interactively processing user operation information of digital television and an associated device, to improve security and convenience of the user operation information and further to obtain better user experience.

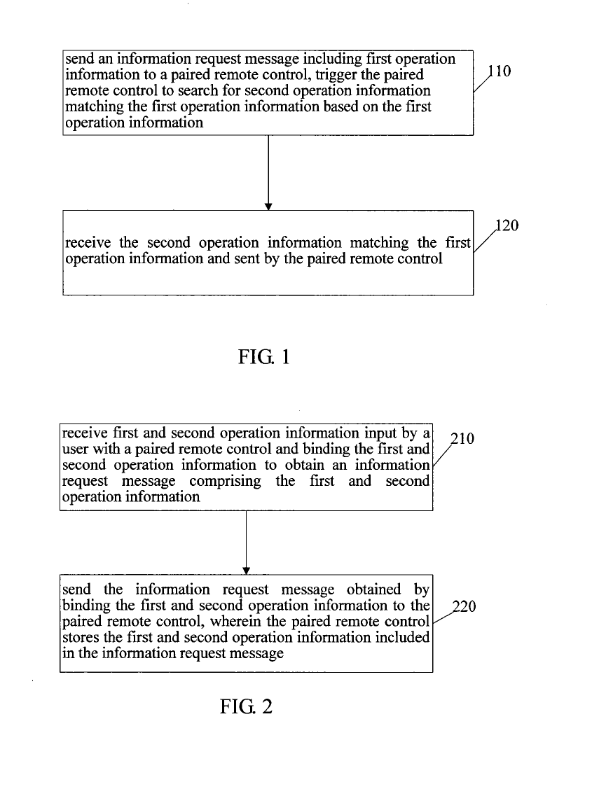

As shown in FIG. 1, an embodiment of the present disclosure provides a method for interactively processing user operation information of digital television, mainly including steps as follows.

In step 110, an information request message including first operation information is sent to a paired remote control, causing the paired remote control to search for second operation information matching the first operation information based on the first operation information.

In the embodiment of the present disclosure, an executive subject may be a digital television/set-top box. Pairing or mutual authentication is performed between the digital television/set-top box and the remote control, and thereby a relatively secure information transmission channel is established between the digital television/set-top box and the remote control which are paired. A wireless transmission protocol or Bluetooth technology may be employed in the information transmission channel, of course infrared ray technology may also be employed, which is not limited herein.

Preferably, attack by interception can be prevented since the Bluetooth technology having a certain security mechanism is employed in the information transmission channel. If the Bluetooth technology is employed, a pairing operation between the digital television/set-top box and the remote control mainly includes steps as follows.

In step S1, a Bluetooth password for the remote control is set and stored in a local storage;

In step S2, a Bluetooth password for the digital television/set-top box is set and stored in the local storage.

A storage is added in the remote control paired with the digital television/set-top box, such that the remote control has a storing function.

Functions of the digital television are similar to those of a computer, including not only a simple TV program watching function but also network functions such as webpage browsing, micro blog login, and online shopping. In this case, much private user operation information, such as user account number and secret code, may be involved. In the embodiment of the present disclosure, the private user operation information is stored in the remote control.

Specifically, if the user operation information is input not for the first time, the digital television/set-top box acquires the second operation information matching the first operation information by sending the information request message including the first operation information to the paired remote control, and thereby login operation by the user is completed.

In step 120, the second operation information matching the first operation information and sent by the paired remote control is received.

The digital television/set-top box receives the second operation information to complete a user login.

In the embodiment of the present disclosure, in a case that the first and second operation information needed for login by the user has been stored in the remote control, by sending the information request message including the first operation information to the paired remote control, the second operation information matching the first operation information is obtained and the login is completed. The operation is simple and convenient for the user.

As shown in FIG. 2, in the case that the first and second operation information are input for the first time, a method for interactively processing user operation information of digital television according to an embodiment of the present disclosure includes steps as follows.

In step 210, first and second operation information input by a user with a paired remote control is received and bound to obtain an information request message which includes the first and second operation information.

In the embodiment of the present disclosure, an executive subject may be a digital television/set-top box. If the first and second operation information are input for the first time, the user inputs the first and second operation information directly with the remote control, the digital television/set-top box binds the first and second operation information and then sends the bound first and second operation information to the paired remote control, and the first and second operation information are stored by the paired remote control.

In step 220, the information request message obtained by binding the first and second operation information is sent to the paired remote control, where the paired remote control stores the first and second operation information included in the information request message.

Specifically, after an information transmission channel between the digital television/set-top box and the paired remote control is initiated, the bound first and second operation information are sent to and then stored by the paired remote control.

Further, the first operation information may be stored in an identification information list in an application.

In the embodiment of the present disclosure, if the first and second operation information are input for the first time, the first and second operation information are bound and then sent to and stored by the paired remote control. Thereby, in a case that the first and the second operation information are to be used later, the first and second operation information may be acquired directly from the paired remote control. Thereby the convenience of user operation is improved.

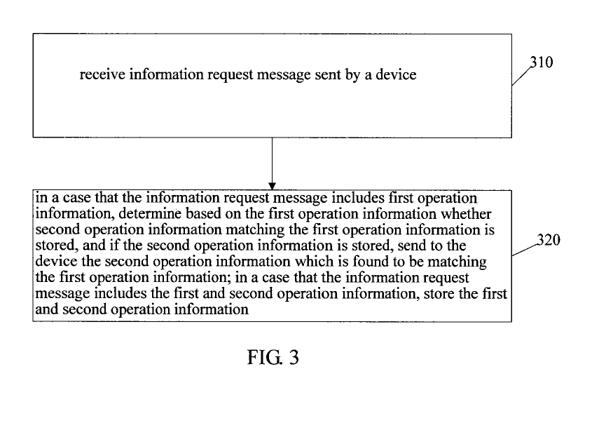

As shown in FIG. 3, an embodiment of the present disclosure provides another method for interactively processing user operation information of digital television, including steps as follows.

In step 310, an information request message sent by a device is received.

Specifically, in the embodiment of the present disclosure, an executive subject is a remote control which is paired with a digital television/set-top box. If the digital television/set-top box needs to acquire the user operation information stored in the remote control or needs to store the user operation information in the remote control, the information request message is firstly sent to the remote control.

In step 320, in the case that the information request message includes first operation information, it is determined based on the first operation information whether second operation information matching the first operation information is stored. If yes, the second operation information which is found to be matching the first operation information is sent to the device. In a case that the information request message includes the first and second operation information, the first and second operation information are stored.

Specifically, the remote control performs determination to the information request message, if the information request message includes the first operation information, it is determined, based on the first operation information, whether the second operation information matching the first operation information is stored in the remote control. If yes, the second operation information which is found to be matching the first operation information is returned to the digital television/set-top box.

If the information request message includes the first and second operation information, then the first and second operation information are stored.

In the embodiment of the present disclosure, it is convenient for operation by the user by storing the user operation information in the remote control. The information transmission channel between the remote control and the digital television/set-top box is used only when they communicate with each other; thereby the user operation information is prevented from being stolen when the network is open. Moreover, the protection for user operation information is further improved based on a nature condition of the remote control since the remote control only can be effective around the digital television/set-top box.

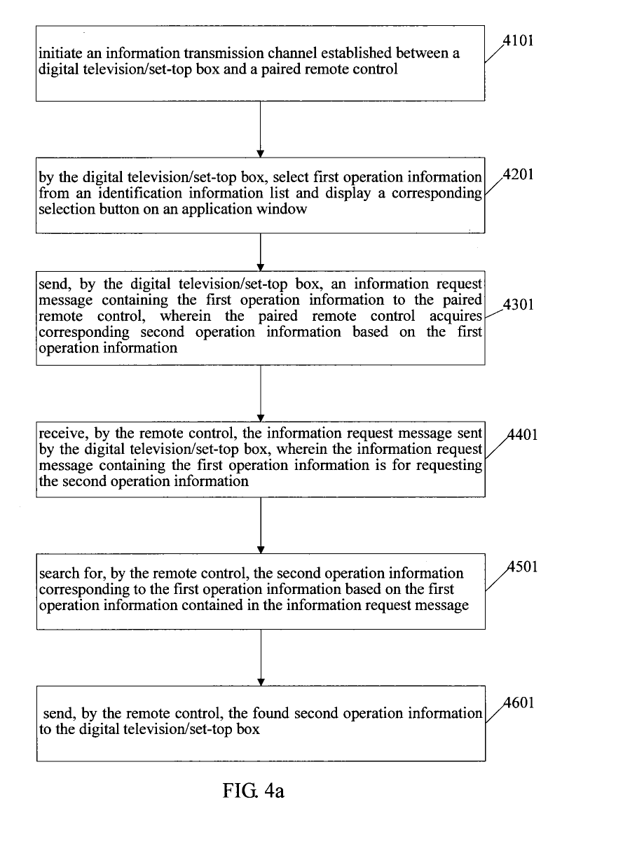

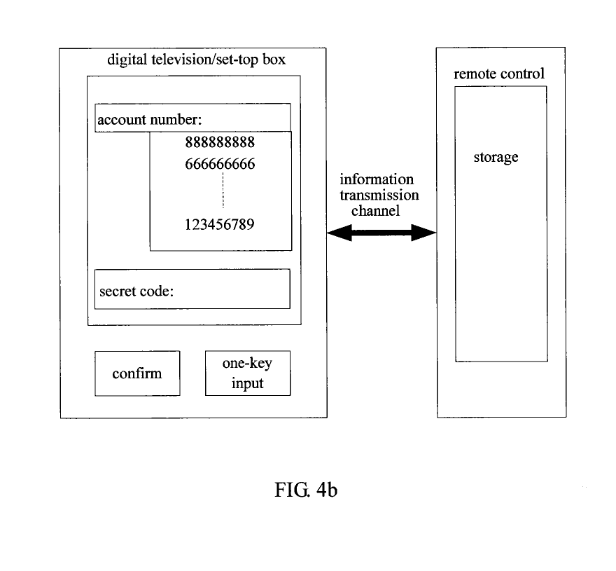

Referring to FIGS. 4a and 4b, an embodiment of the present disclosure is described in detail based on the fact that first and second operation information needed by the user to log in have been stored in the paired remote control. A method for interactively processing user operation information of digital television includes steps as follows.

In step 4101, an information transmission channel established between a digital television/set-top box and a paired remote control is initiated.

The digital television/set-top box communicates with the remote control using a wireless transmission protocol, and the information transmission channel is initiated if information is to be transmitted between the digital television/set-top box and the paired remote control.

In step 4201, the digital television/set-top box selects the first operation information from an identification information list and displays a corresponding selection button on an application window.

A user account number and a secret code are necessary user operation information when the user, by using the network with the digital television, logs in a mailbox, micro blog and logs in PayPal or other online banks for payment. The digital television/set-top box opens a corresponding application interface based on user requirement and acquires the first operation information from the identification information list.

Preferably, the first operation information may be the user account number for logging in the application. The first operation information may be input directly by the user with the remote control. Or, it may be checked whether the identification information displayed on the application window includes the first operation information, if yes, the first operation information is selected directly form the identification information.

In the embodiment of the present disclosure, it is mainly to acquire the second operation information from the paired remote control. Therefore, there is an “OK” button for confirming a login of an application. There is also a “one-button input” button for acquiring the second operation information corresponding to the first operation information from the paired remote control. It is assumed that, in the embodiment, the first operation information corresponds to an account number for logging in the application, there are multiple account numbers stored in local identification information, and from which the account “888888888” is selected.

In step 4301, the digital television/set-top box sends information request information containing the first operation information to the paired remote control, causing the paired remote control to acquire corresponding second operation information based on the first operation information.

Specifically, the digital television/set-top box receives a triggering event of the “one-key input” button and sends the information request message for requesting the second operation information to the remote control based on the first operation information, the information request message carries the first operation information, such that the remote control finds the corresponding second operation information based on the first operation information.

In step 4401, the remote control receives the information request message sent by the digital television/set-top box. The information request message containing the first operation information is for requesting the second operation information.

The information request message containing the first operation information is received via the information transmission channel established between the digital television/set-top box and the remote control.

In step 4501, the remote control searches for, based on the first operation information contained in the information request message, the second operation information corresponding to the first operation information.

Specifically, the remote control searches for, based on the first operation information in the received information request message, the second operation information corresponding to the first operation information.

In step 4601, the remote control sends the found second operation information to the digital television/set-top box.

Specifically, the remote control sends the found second operation information to the digital television/set-top box to complete the login of application.

The embodiment of the present disclosure is mainly for the case that the user operation information needed to be used has been stored in the remote control. After a button event for acquiring the second operation information is received, a request containing the first operation information is sent to the paired remote control. The remote control searches for the corresponding second operation information based on the first operation information, sends the second operation information to the digital television/set-top box, and thereby completes the login of the application. It is secure and reliable to store the user operation information with the remote control.

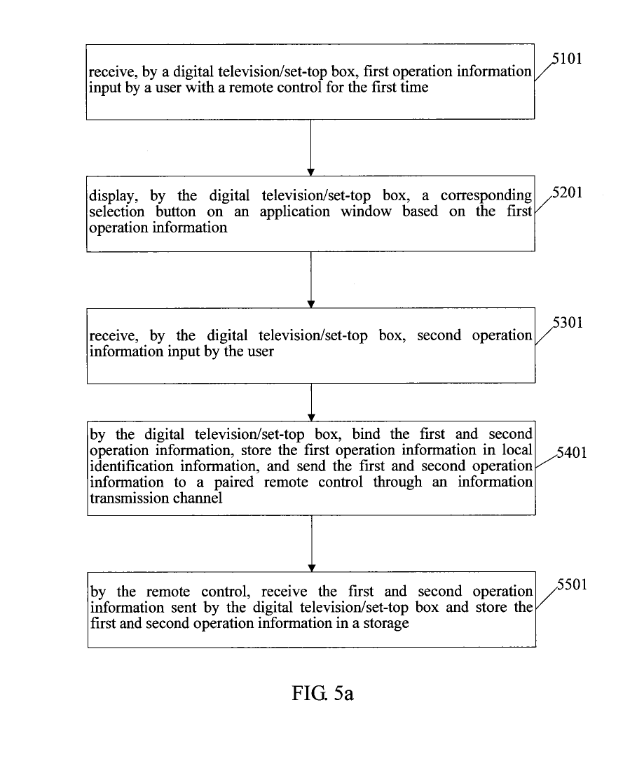

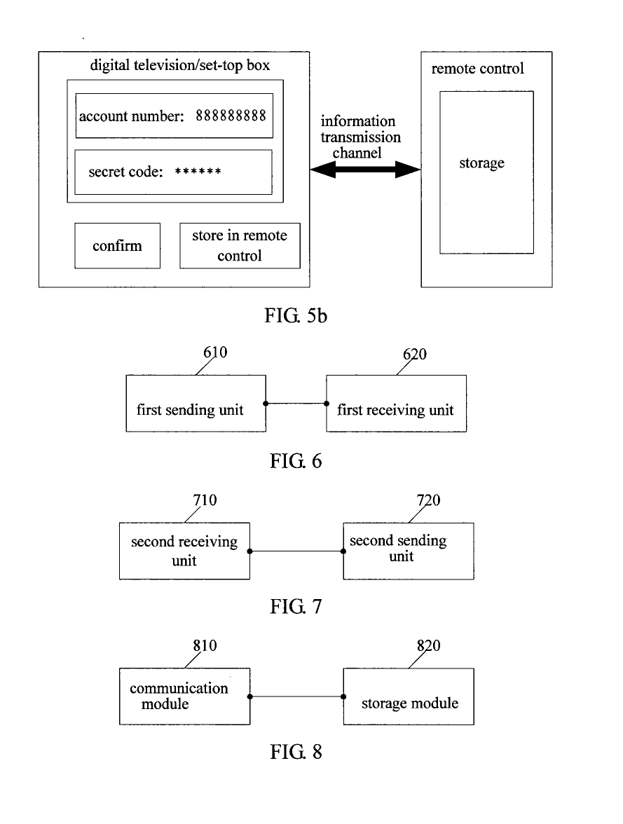

As shown in FIGS. 5a and 5b, a method for interactively processing user operation information of digital television includes steps as follows.

In step 5101, a digital television/set-top box receives first operation information input by a user with a remote control for the first time.

Specifically, referring to FIG. 5b, the first operation information is an account number used for login of application on an application window. Assuming that the account number is “888888888”, the account number information input by the user is received.

In step 5201, the digital television/set-top box displays a corresponding selection button on an application window based on the first operation information.

Specifically, in a case that the acquired corresponding first operation information is displayed on a location in the application window for displaying the first operation information, the corresponding selection button is displayed on the window since the first operation information is input for the first time. Where a “confirm” button is for confirming a login of the application by the user, and a “store in the remote control” button is for sending the first and second operation information to the remote control for storage.

In step 5301, the digital television/set-top box receives the second operation information input by the user.

Specifically, a screen cursor is moved to a secret code column to receive the second operation information input by the user. In the embodiment of the present disclosure, the second operation information is the secret code. Assuming that the secret code is “888888”, the secret code is displayed with asterisks “******” instead of “888888”, according to a secret code invisible display.

In step 5401, the digital television/set-top box binds the first and second operation information, stores the first operation information in local identification information, and sends the first and second operation information to the paired remote control via the information transmission channel.

Specifically, the user operation information used by the application, i.e. the account number in the embodiment of the present disclosure, is stored in the identification information. Then, when a user logs in the application later, the identification information is displayed on the screen for the user to select directly, thereby the convenience of the user operation is improved. Moreover, when the “store in the remote control” button is pressed, the first and second operation information are sent to the paired remote control.

In step 5501, the remote control receives the first and second operation information sent by the digital television/set-top box and stores the first and second operation information in a storage.

Specifically, the storage is added in the paired remote control. The remote control receives the first and second operation information through the information transmission channel and stores the first and second operation information in the storage.

In the embodiment of the present disclosure, it is described in detail the case that the first operation information is input for the first time. After receiving a key event of “store in the remote control”, the digital television/set-top box binds the acquired first and second operation information and then sends the bound first and second operation information to the remote control. Therefore, with the remote control, the user operation information is stored securely and prevented from intercepting and attacking, and thereby it is convenient to be used later. Moreover, it is more convenient for the user to operate later that the first operation information is stored in the local identification information.

As shown in FIG. 6, a device according to an embodiment of the present disclosure may includes:
a first sending unit 610, configured to send an information request message including first operation information to a paired remote control, trigger the paired remote control to search for second operation information matching the first operation information based on the first operation information; and
a first receiving unit 620, configured to receive the second operation information matching the first operation information and sent by the paired remote control.

It may be understood that, the device may further include an initiating unit which is mainly configured to initiate an information transmission channel built to the device.

As shown in FIG. 7, a device further provided by an embodiment of the present disclosure may includes:
a second receiving unit 710, configured to receive first and second operation information input by a user with a paired remote control and bind the first and second operation information to obtain an information request message including the first and second operation information; and
a second sending unit 720, configured to send the information request message obtained by binding the first and second operation information to the paired remote control, trigger the paired remote control to store the first and second operation information included in the information request message.

As shown in FIG. 8, a remote control further provided by an embodiment of the present disclosure may includes:
a communication module 810, configured to receive an information request message sent by a device and send to the device second operation information which is found to be matching first operation information; and
a storage module 820, configure to determine, based on the first operation information, whether the second operation information matching the first operation information is stored and search for the second operation information matching the first operation information, in a case that the information request message includes the first operation information; and store the first and second operation information in a case that the information request message includes the first and second operation information.

The device as shown in FIGS. 6 and 7 may be a digital television or a set-top box. In practical applications, a secure information transmission channel is established between the digital television/set-top box and the remote control with a Bluetooth technology, a storage is added in the remote control and the digital television/set-top box stores the user operation information in the remote control through the information transmission channel. Therefore, the user operation information is prevented from intercepting or attacking and is ensured to be secure, so it is convenient for the user to use the stored user operation information later, and thereby user experience is improved.

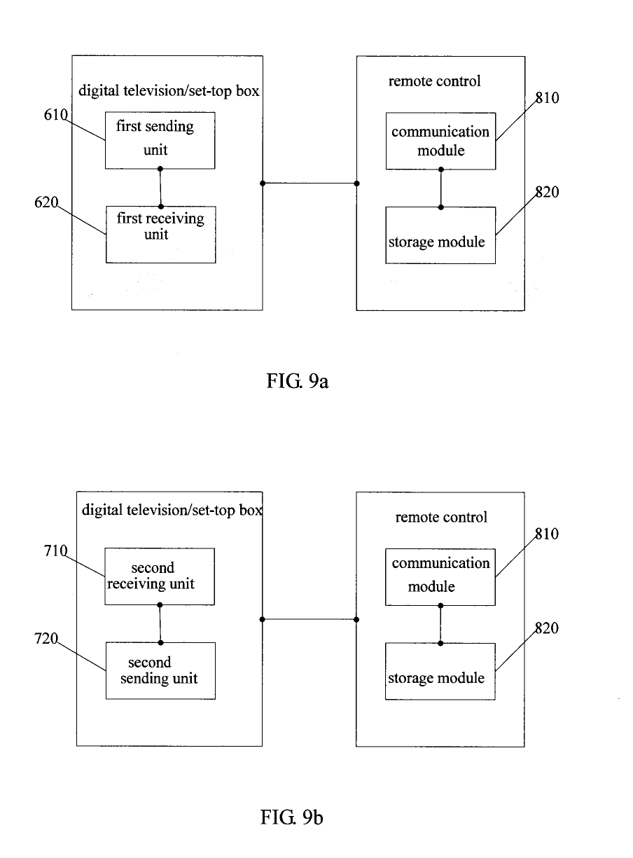

As shown in FIGS. 9a and 9b, an embodiment of the present disclosure further provides a system for interactively processing user operation information of digital television, mainly including the device as shown in FIG. 6 or 7, and the remote control as shown in FIG. 8.

As shown in FIG. 9a, the system mainly includes the device as shown in FIG. 6 and the remote control as shown in FIG. 8. Specifically, the device may be a digital television or set-top box which mainly includes:
the first sending unit 610, configured to send an information request message including first operation information to a paired remote control, trigger the paired remote control to search for second operation information matching the first operation information based on the first operation information; and
the first receiving unit 620, configured to receive the second operation information matching the first operation information and sent by the paired remote control.

And the remote control mainly includes:
the communication module 810, configured to receive an information request message sent by a device and send to the device second operation information which is found to be matching first operation information; and
the storage module 820, configured to determine, based on the first operation information, whether the second operation information matching the first operation information is stored and search for the second operation information matching the first operation information, in a case that the information request message includes the first operation information; and store the first and second operation information in a case that the information request message includes the first and second operation information.

As shown in FIG. 9b, the system mainly includes the device as shown in FIG. 7 and the remote control as shown in FIG. 8. Similarly, the device may be a digital television or set-top box which mainly includes:
the second receiving unit 710, configure to receive first and second operation information input by a user with a paired remote control and bind the first and second operation information to obtain an information request message including the first and second operation information; and
the second sending unit 720, configured to send the information request message obtained by binding the first and second operation information to the paired remote control, wherein the paired remote control stores the first and second operation information included in the information request message.

The remote control mainly includes:
the communication module 810, configured to receive an information request message sent by a device and send to the device second operation information which is found to be matching first operation information; and
the storage module 820, configured to determine, based on the first operation information, whether the second operation information matching the first operation information is stored and search for the second operation information matching the first operation information, in a case that the information request message includes the first operation information; and store the first and second operation information in the case that the information request message includes the first and second operation information.

In the embodiment of the present disclosure, the user operation information is stored in the remote control. A natural condition for storing the user operation information securely is provided, since the remote control is separated physically from the digital television/set-top box and the remote control, of which function is limited when being brought outdoors, can only be used around the digital television/set-top box. In addition, a wireless transmission protocol is employed between the digital television/set-top box and the remote control, so that the user operation information can not be stolen during the transmission of the user operation information, thereby security and convenience of the operation are both provided.

It may be understood by those skilled in the art that, all of or part of the steps in the above embodiments may be completed by a program through instructing associated hardware. The program may be stored in a computer readable storage medium which may be a Read Only Memory (ROM), a magnetic disk, an optical disk, or the like.

In the above, the method and system for interactively processing user operation information of digital television and an associated device provided by the present disclosure are described in detail. For those skilled in the art, there may be changes in specific embodiments and an application range, in light of the concept of the embodiments of the present disclosure. In summary, the specification should not be construed as limiting the present disclosure.

1. A method for interactively processing user operation information of digital television, comprising:
sending an information request message including first operation information to a paired remote control, triggering the paired remote control to search for second operation information matching the first operation information based on the first operation information; and
receiving the second operation information matching the first operation information sent by the paired remote control.

2. The method according to claim 1, wherein before the sending the information request message to the paired remote control, the method further comprises:
searching for the first operation information in an identification information list of application, wherein the identification information list of application is used for storing the first operation information.

3. The method according to claim 1 or 2, wherein before the sending the information request message to the paired remote control, the method further comprises:
initiating an information transmission channel established to the paired remote control.

4. A method for interactively processing user operation information of digital television, comprising:
receiving first and second operation information input by a user with a paired remote control and binding the first and second operation information to obtain an information request message comprising the first and second operation information; and
sending the information request message obtained by binding the first and second operation information to the paired remote control, triggering the paired remote control to store the first and second operation information comprised in the information request message.

5. The method according to claim 4, further comprising:
storing the first operation information in an identification information list of application.

6. The method according to claim 4, wherein before the receiving the first and second operation information input by the user with the paired remote control, the method further comprises:
initiating an information transmission channel established to the paired remote control.

7. A method for interactively processing user operation information of digital television, comprising:
receiving information request message sent by a device;
wherein, in the case that the information request message comprises first operation information, it is determined based on the first operation information whether second operation information matching the first operation information is stored, and if yes, the second operation information which is found to be matching the first operation information is sent to the device; in the case that the information request message comprises the first and second operation information, the first and second operation information are stored.

8. The method according to claim 7, wherein before the receiving the information request message sent by the device, the method further comprises:
initiating an information transmission channel established to the device.

9. A device, comprising:
a first sending unit, configured to send an information request message comprising first operation information to a paired remote control, trigger the paired remote control to search for second operation information matching the first operation information based on the first operation information; and
a first receiving unit, configured to receive the second operation information matching the first operation information and sent by the paired remote control.

10. A device, comprising:
a second receiving unit, configured to receive first and second operation information input by a user with a paired remote control and bind the first and second operation information to obtain an information request message comprising the first and second operation information; and
a second sending unit, configured to send the information request message obtained by binding the first and second operation information to the paired remote control, trigger the paired remote control to store the first and second operation information comprised in the information request message.

11. A remote control, comprising:
a communication module, configured to receive an information request message sent by a device and send to the device second operation information which is found to matching first operation information; and
a storage module, configured to determine, based on the first operation information, whether the second operation information matching the first operation information is stored and search for the second operation information matching the first operation information, in a case that the information request message comprises the first operation information; and store the first and second operation information, in a case that the information request message comprises the first and second operation information.

12. A system for interactively processing user operation information of digital television, comprising:
a device comprising: a first sending unit, configured to send an information request message comprising first operation information to a paired remote control, trigger the paired remote control to search for second operation information matching the first operation information based on the first operation information; and a first receiving unit, configured to receive the second operation information matching the first operation information and sent by the paired remote control; and
a remote control comprising: a communication module, configured to receive an information request message sent by a device and send to the device second operation information which is found to matching first operation information; and a storage module, configured to determine, based on the first operation information, whether the second operation information matching the first operation information is stored and search for the second operation information matching the first operation information, in a case that the information request message comprises the first operation information; and store the first and second operation information, in a case that the information request message comprises the first and second operation information.

13. The method according to claim 2, wherein before the sending the information request message to the paired remote control, the method further comprises:
initiating an information transmission channel established to the paired remote control.

14. The method according to claim 5, wherein before the receiving the first and second operation information input by the user with the paired remote control, the method further comprises:
initiating an information transmission channel established to the paired remote control.

15. A system for interactively processing user operation information of digital television, comprising:
a device comprising: a second receiving unit, configured to receive first and second operation information input by a user with a paired remote control and bind the first and second operation information to obtain an information request message comprising the first and second operation information; and a second sending unit, configured to send the information request message obtained by binding the first and second operation information to the paired remote control, trigger the paired remote control to store the first and second operation information comprised in the information request message; and
a remote control comprising: a communication module, configured to receive an information request message sent by a device and send to the device second operation information which is found to matching first operation information; and a storage module, configured to determine, based on the first operation information, whether the second operation information matching the first operation information is stored and search for the second operation information matching the first operation information, in a case that the information request message comprises the first operation information; and store the first and second operation information, in a case that the information request message comprises the first and second operation information.
